(19) United States
(12) Patent Application Publication
(10) Pub. No.: US 2025/0005317 A1
(43) Pub. Date: Jan. 2, 2025

(54) METHOD FOR PROVIDING A CUSTOMIZED VISUAL COMPANION WITH ARTIFICIAL INTELLIGENCE

(71) Applicant: BitHuman Inc

(72) Inventors: Yun Fu, Newton, MA (US); Steve Gu, Lafayette, CA (US)

(73) Assignee: BitHuman Inc, (omitted)

(21) Appl. No.: 18/217,605

(22) Filed: Jul. 2, 2023

(51) Int. Cl. G06N 3/006; G06F 3/01

(52) U.S. Cl. CPC G06N 3/006; G06F 3/013

(57) ABSTRACT

Embodiments of the present disclosure may include a method for providing an encounter via a customized virtual assistant with artificial intelligence, the method including detecting, by one or more processors, an encounter request from a user.

### BACKGROUND OF THE INVENTION

Embodiments of the present disclosure may include a method for providing an encounter via a customized virtual assistant with artificial intelligence (AI) and thus provide many other novel and useful features.

### BRIEF SUMMARY

Embodiments of the present disclosure may include a method for providing an encounter via a virtual companion with artificial intelligence, the method including detecting, by one or more processors, an encounter request from a user. In some embodiments, an artificial intelligence engine may be coupled to the one or more processors. In some embodiments, the artificial intelligence engine may be trained by human experts in the field.

In some embodiments, the virtual companion may be configured to be displayed in LED/OLED displays, Android/iOS tablets, Laptops/PCs, or VR/AR goggles. In some embodiments, a set of multi-layer info panels coupled to the one or more processors may be configured to overlay graphics on top of the virtual companion. In some embodiments, the visual assistant may be configured to be displayed with an appearance of a real human or a humanoid, or a cartoon character based on the user's choice.

In some embodiments, a set of pictures depicting the user's choice can be uploaded to the artificial intelligence engine. In some embodiments, the appearance of the visual assistant could be determined by analysis of the set of pictures by the artificial intelligence engine. In some embodiments, the visual assistant may be configured to mimic different personalities.

In some embodiments, the visual assistant's gender, age and ethnicity may be determined by the artificial Intelligence's analysis on input from the user. In some embodiments, the virtual companion may be configured to be displayed in full body or half body portrait mode. In some embodiments, the artificial intelligence engine may be configured for real-time speech recognition, speech to text generation, real-time dialog generation, text to speech generation, voice-driven animation, and human avatar generation.

In some embodiments, the artificial intelligence engine may be configured to emulate different voices and use different languages. Embodiments may also include detecting and tracking the user's face, eye, and pose by a set of outward-facing cameras coupled to the one or more processors. In some embodiments, a set of touch screens coupled to the one or more processors may be configured to allow the user to interact with the visual assistant by hand.

Embodiments may also include detecting the user's voice by a set of microphones coupled to the one or more processors. In some embodiments, the set of microphones may be connected to loudspeakers. In some embodiments, the set of microphones may be enabled to be beamforming. In some embodiments, pictures or voices of the user may be configured to be uploaded and processed either on a cloud server or in local or personal devices to analyze and create the virtual companion.

In some embodiments, the virtual companion may be configured to be created based on the appearance of a real human character, user's own appearance, or a totally unidentifiable appearance created by the artificial intelligence. Embodiments may also include analyzing user's personality and demographic information from audio-visual information gathered by the set of outward-facing cameras and the set of microphones.

Embodiments may also include selecting a best-matching personality for the user from a set of personalities based the analysis of the user's personality and demographic information from audio-visual information. Embodiments may also include selecting a goal model from a set of goal models that each reflects a different type of assistance to be provided to the user by the virtual companion.

In some embodiments, the selection of the goal model may be based on the input of the user based on the needs of the user after the user enters into the encounter area and analysis of the artificial intelligence engine. In some embodiments, the set of goal models may be generated from the artificial intelligence with a number of human experts with non-public expertise.

In some embodiments, non-public expertise may include knowledge, human interaction, human characters, human conversation, and human physiology. Embodiments may also include selecting, by the one or more processors and the artificial intelligence engine, based on the goal model and responsive to the encounter request, a first encounter including a first representation and a first dialog output.

In some embodiments, the first encounter may be configured to include a first set of body movements and a first set of sign language by the visual companion. Embodiments may also include providing, by the one or more processors and the artificial intelligence engine, based on the goal model and responsive to the encounter request, the first encounter for presentation to the user on the virtual companion.

Embodiments may also include receiving, by the one or more processors and from the user, a first user reaction, the first user reaction including a first user dialog input and a first user engagement input. Embodiments may also include selecting, based on the first user reaction and using the goal model, a second encounter including a second representation and a second dialog output. In some embodiments, the second encounter may be configured to include a second set of body movements and a second set of sign language by the visual companion. Embodiments may also include providing, the second encounter for presentation to the user on the virtual companion.

Embodiments of the present disclosure may also include a method for providing an encounter via a virtual companion with artificial intelligence. In some embodiments, the visual companion may be providing a service of senior care.

Embodiments of the present disclosure may also include a method for providing an encounter via a virtual companion with artificial intelligence. In some embodiments, the visual companion may be providing a service of visual dating service.

Embodiments of the present disclosure may also include a method for providing an encounter via a virtual companion for one or more users, with artificial intelligence, the method including detecting, by one or more processors, an encounter request from the one or more users. In some embodiments, an artificial intelligence engine may be coupled to the one or more processors.

In some embodiments, the artificial intelligence engine may be trained by human experts in the field. In some embodiments, the virtual companion may be configured to be displayed in LED/OLED displays, Android/iOS tablets, Laptops/PCs, or VR/AR goggles. In some embodiments, a set of multi-layer info panels coupled to the one or more processors may be configured to overlay graphics on top of the virtual companion.

In some embodiments, the visual assistant may be configured to be displayed with an appearance of a real human or a humanoid or a cartoon character based on the one or more users' choice. In some embodiments, a set of pictures depicting the one or more users' choice can be uploaded to the artificial intelligence engine. In some embodiments, the appearance of the visual assistant could be determined by analysis of the set of pictures by the artificial intelligence engine.

In some embodiments, the visual assistant may be configured to mimic different personalities. In some embodiments, the visual assistant's gender, age and ethnicity may be determined by the artificial Intelligence's analysis on input from the one or more users. In some embodiments, the virtual companion may be configured to be displayed in full body or half body portrait mode.

In some embodiments, the artificial intelligence engine may be configured for real-time speech recognition, speech to text generation, real-time dialog generation, text to speech generation, voice-driven animation, and human avatar generation. In some embodiments, the artificial intelligence engine may be configured to emulate different voices and use different languages.

Embodiments may also include detecting and tracking the one or more users' face, eye, and pose by a set of outward-facing cameras coupled to the one or more processors. In some embodiments, a set of touch screens coupled to the one or more processors may be configured to allow the one or more users to interact with the visual assistant by hand. Embodiments may also include detecting the one or more users' voice by a set of microphones coupled to the one or more processors.

In some embodiments, the set of microphones may be connected to loudspeakers. In some embodiments, the set of microphones may be enabled to be beamforming. In some embodiments, pictures or voices of the one or more users may be configured to be uploaded and processed either on a cloud server or in local or personal devices to analyze and create the virtual companion.

In some embodiments, the virtual companion may be configured to be created based on the appearance of a real human character, the one or more user's own appearance, or a totally unidentifiable appearance created by the artificial intelligence. Embodiments may also include analyzing one or more users' personality and demographic information from audio-visual information gathered by the set of outward-facing cameras and the set of microphones.

Embodiments may also include selecting a best-matching personality for the one or more users from a set of personalities based the analysis of the one or more users' personality and demographic information from audio-visual information. In some embodiments, the visual companion may be configured to have eye contact with the one or more users. In some embodiments, the visual companion may be configured to differentiate and identify the one or more users.

In some embodiments, the visual companion may be configured to switch eye contact when interacting with multiple users. In some embodiments, the visual companion may be configured to switch to different personalities based on the analysis of one user who the visual companion has eye contact with and has communicated with. In some embodiments, the one user may be one user out of the one or more users.

In some embodiments, the virtual companion may be configured to shift interaction modes between one-to-one mode and one-to-more mode by using eye contact, pose and focus of attention. Embodiments may also include selecting a goal model from a set of goal models that each reflects a different type of assistance to be provided to the one or more users by the virtual companion.

In some embodiments, the selection of the goal model may be based on the input of the one or more users based on the needs of the one or more users after the one or more users enters into the encounter area and analysis of the artificial intelligence engine. In some embodiments, the set of goal models may be generated from the artificial intelligence with a number of human experts with non-public expertise.

In some embodiments, non-public expertise may include knowledge, human interaction, human characters, human conversation and human physiology. Embodiments may also include selecting, by the one or more processors and the artificial intelligence engine, based on the goal model and responsive to the encounter request, a first encounter including a first representation and a first dialog output.

In some embodiments, the first encounter may be configured to include a first set of body movements and a first set of sign language by the visual companion. Embodiments may also include providing, by the one or more processors and the artificial intelligence engine, based on the goal model and responsive to the encounter request, the first encounter for presentation to the one or more users on the virtual companion.

Embodiments may also include receiving, by the one or more processors and from the one or more users, a first one or more users' reaction, the first one or more users reaction including a first one or more users dialog input and a first one or more users engagement input. Embodiments may also include selecting, based on the first one or more users' reaction and using the goal model, a second encounter including a second representation and a second dialog output. In some embodiments, the second encounter may be configured to include a second set of body movements and a second set of sign language by the visual companion. Embodiments may also include providing, the second encounter for presentation to the one or more users on the virtual companion. In some embodiments, the visual companion may be providing a service of senior care. In some embodiments, the visual companion may be a service of visual dating service.

Embodiments of the present disclosure may also include a method for providing an encounter via a virtual companion for one or more users, with artificial intelligence, the method including detecting, by one or more processors, an encounter request from the one or more users. In some embodiments, an artificial intelligence engine may be coupled to the one or more processors.

In some embodiments, the artificial intelligence engine may be trained by human experts in the field. In some embodiments, the virtual companion may be configured to be displayed in LED/OLED displays, Android/iOS tablets, Laptops/PCs, or VR/AR goggles. In some embodiments, a set of multi-layer info panels coupled to the one or more processors may be configured to overlay graphics on top of the virtual companion.

In some embodiments, the visual assistant may be configured to be displayed with an appearance of a real human or a humanoid or a cartoon character based on the one or more users' choice. In some embodiments, a set of pictures depicting the one or more users' choice can be uploaded to the artificial intelligence engine. In some embodiments, the appearance of the visual assistant could be determined by analysis of the set of pictures by the artificial intelligence engine.

In some embodiments, the visual assistant may be configured to mimic different personalities. In some embodiments, the visual assistant's gender, age and ethnicity may be determined by the artificial Intelligence's analysis on input from the one or more users. In some embodiments, the virtual companion may be configured to be displayed in full body or half body portrait mode.

In some embodiments, the artificial intelligence engine may be configured for real-time speech recognition, speech to text generation, real-time dialog generation, text to speech generation, voice-driven animation, and human avatar generation. In some embodiments, the artificial intelligence engine may be configured to emulate different voices and use different languages.

Embodiments may also include detecting and tracking the one or more users' face, eye, and pose by a set of outward-facing cameras coupled to the one or more processors. In some embodiments, a set of touch screens coupled to the one or more processors may be configured to allow the one or more users to interact with the visual assistant by hand. Embodiments may also include detecting the one or more users' voice by a set of microphones coupled to the one or more processors.

In some embodiments, the set of microphones may be connected to loudspeakers. In some embodiments, the set of microphones may be enabled to be beamforming. In some embodiments, pictures or voices of the one or more users may be configured to be uploaded and processed either on a cloud server or in local or personal devices to analyze and create the virtual companion.

In some embodiments, the virtual companion may be configured to be created based on the appearance of a real human character, the one or more user's own appearance, or a totally unidentifiable appearance created by the artificial intelligence. Embodiments may also include analyzing one or more users' personality and demographic information from audio-visual information gathered by the set of outward-facing cameras and the set of microphones.

### BRIEF DESCRIPTION OF THE FIGURES

FIG. 1A is a flowchart illustrating a method for providing an encounter, according to some embodiments of the present disclosure.

FIG. 1B is a flowchart extending from FIG. 1A and further illustrating the method for providing an encounter, according to some embodiments of the present disclosure.

FIG. 2A is a flowchart illustrating a method for providing an encounter, according to some embodiments of the present disclosure.

FIG. 2B is a flowchart extending from FIG. 2A and further illustrating the method for providing an encounter, according to some embodiments of the present disclosure.

FIG. 3 is a flowchart illustrating a method for providing an encounter, according to some embodiments of the present disclosure.

FIG. 4 is a diagram showing an example of providing an encounter of a visual assistant.

FIG. 5 is a diagram showing a second example of providing an encounter of a visual assistant.

FIG. 6 is a diagram showing another example of providing an encounter of a visual assistant.

### DETAILED DESCRIPTION

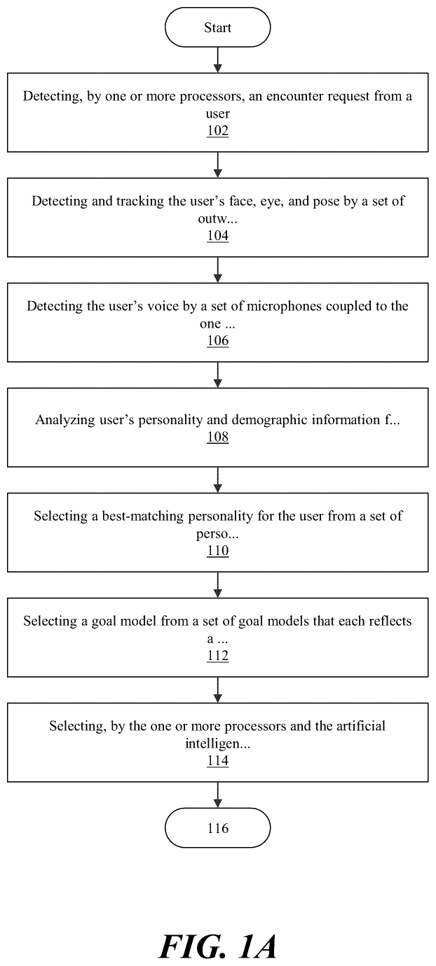

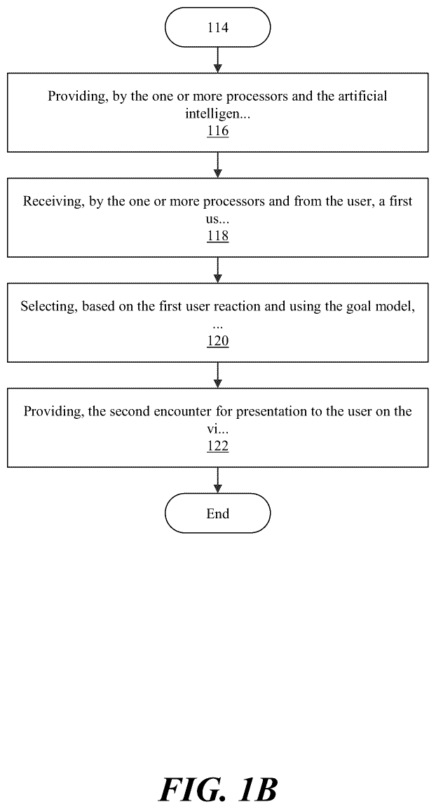

FIGS. 1A to 1B are flowcharts that describe a method for providing an encounter, according to some embodiments of the present disclosure. In some embodiments, at 102, the method may include detecting, by one or more processors, an encounter request from a user. At 104, the method may include detecting and tracking the user's face, eye, and pose by a set of outward-facing cameras coupled to the one or more processors. At 106, the method may include detecting the user's voice by a set of microphones coupled to the one or more processors.

In some embodiments, at 108, the method may include analyzing user's personality and demographic information from audio-visual information gathered by the set of outward-facing cameras and the set of microphones. At 110, the method may include selecting a best-matching personality for the user from a set of personalities based the analysis of the user's personality and demographic information from audio-visual information.

In some embodiments, at 112, the method may include selecting a goal model from a set of goal models that each reflects a different type of assistance to be provided to the user by the virtual companion. At 114, the method may include selecting, by the one or more processors and the artificial intelligence engine, based on the goal model and responsive to the encounter request, a first encounter including a first representation and a first dialog output.

In some embodiments, at 116, the method may include providing, by the one or more processors and the artificial intelligence engine, based on the goal model and responsive to the encounter request, the first encounter for presentation to the user on the virtual companion. At 118, the method may include receiving, by the one or more processors and from the user, a first user reaction, the first user reaction including a first user dialog input and a first user engagement input. At 120, the method may include selecting, based on the first user reaction and using the goal model, a second encounter including a second representation and a second dialog output. At 122, the method may include providing, the second encounter for presentation to the user on the virtual companion.

In some embodiments, an artificial intelligence engine may be coupled to the one or more processors. The artificial intelligence engine may be trained by human experts in the field. The virtual companion may be configured to be displayed in LED/OLED displays, Android/iOS tablets, Laptops/PCs, or VR/AR goggles. A set of multi-layer info panels coupled to the one or more processors may be configured to overlay graphics on top of the virtual companion.

In some embodiments, the visual assistant may be configured to be displayed with an appearance of a real human or a humanoid or a cartoon character based on the user's choice. A set of pictures depicting the user's choice can be uploaded to the artificial intelligence engine. The appearance of the visual assistant could be determined by analysis of the set of pictures by the artificial intelligence engine. The visual assistant may be configured to mimic different personalities.

In some embodiments, the visual assistant's gender, age and ethnicity may be determined by the artificial Intelligence's analysis on input from the user. The virtual companion may be configured to be displayed in full body or half body portrait mode. The artificial intelligence engine may be configured for real-time speech recognition, speech to text generation, real-time dialog generation, text to speech generation, voice-driven animation, and human avatar generation.

In some embodiments, the artificial intelligence engine may be configured to emulate different voices and use different languages. A set of touch screens coupled to the one or more processors may be configured to allow the user to interact with the visual assistant by hand. The set of microphones may be connected to loudspeakers. The set of microphones may be enabled to be beamforming. Pictures or voices of the user may be configured to be uploaded and processed either on a cloud server or in local or personal devices to analyze and create the virtual companion.

In some embodiments, the virtual companion may be configured to be created based on the appearance of a real human character, user's own appearance, or a totally unidentifiable appearance created by the artificial intelligence. The selection of the goal model may be based on the input of the user based on the needs of the user after the user may enter into the encounter area and analysis of the artificial intelligence engine.

In some embodiments, the set of goal models may be generated from the artificial intelligence with a number of human experts with non-public expertise. Non-public expertise may comprise knowledge, human interaction, human characters, human conversation, and human physiology. The first encounter may be configured to include a first set of body movements and a first set of sign language by the visual companion. The second encounter may be configured to include a second set of body movements and a second set of sign language by the visual companion.

In some embodiments, the visual companion may be providing a service of senior care.

In some embodiments, the visual companion may be providing a service of visual dating service.

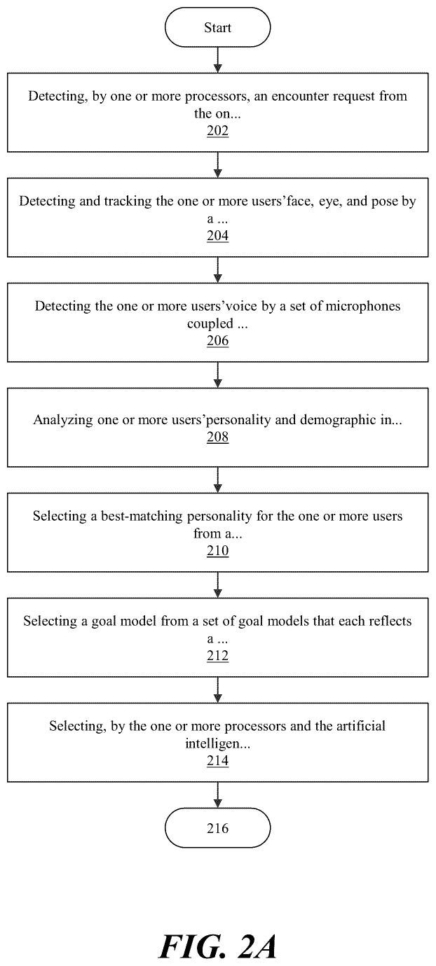

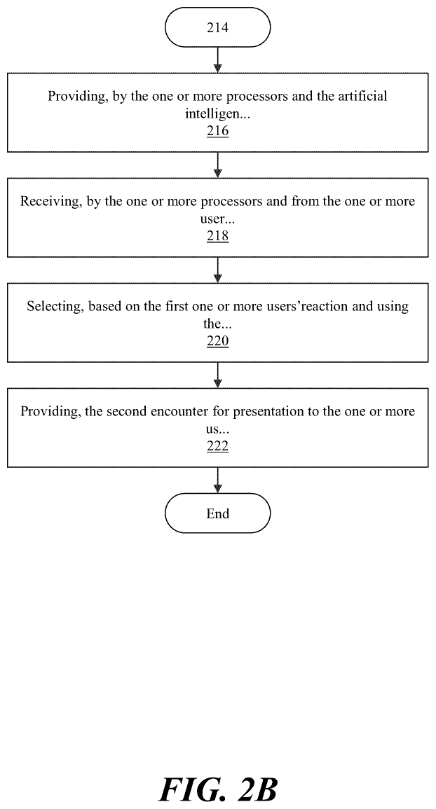

FIGS. 2A to 2B are flowcharts that describe a method for providing an encounter, according to some embodiments of the present disclosure. In some embodiments, at 202, the method may include detecting, by one or more processors, an encounter request from the one or more users. At 204, the method may include detecting and tracking the one or more users' face, eye, and pose by a set of outward-facing cameras coupled to the one or more processors. At 206, the method may include detecting the one or more users' voice by a set of microphones coupled to the one or more processors.

In some embodiments, at 208, the method may include analyzing one or more users' personality and demographic information from audio-visual information gathered by the set of outward-facing cameras and the set of microphones. At 210, the method may include selecting a best-matching personality for the one or more users from a set of personalities based the analysis of the one or more users' personality and demographic information from audio-visual information.

In some embodiments, at 212, the method may include selecting a goal model from a set of goal models that each reflects a different type of assistance to be provided to the one or more users by the virtual companion. At 214, the method may include selecting, by the one or more processors and the artificial intelligence engine, based on the goal model and responsive to the encounter request, a first encounter including a first representation and a first dialog output.

In some embodiments, at 216, the method may include providing, by the one or more processors and the artificial intelligence engine, based on the goal model and responsive to the encounter request, the first encounter for presentation to the one or more users on the virtual companion. At 218, the method may include receiving, by the one or more processors and from the one or more users, a first one or more users' reaction, the first one or more users reaction including a first one or more users dialog input and a first one or more users engagement input. At 220, the method may include selecting, based on the first one or more users' reaction and using the goal model, a second encounter including a second representation and a second dialog output. At 222, the method may include providing, the second encounter for presentation to the one or more users on the virtual companion.

In some embodiments, an artificial intelligence engine may be coupled to the one or more processors. The artificial intelligence engine may be trained by human experts in the field. The virtual companion may be configured to be displayed in LED/OLED displays, Android/iOS tablets, Laptops/PCs, or VR/AR goggles. A set of multi-layer info panels coupled to the one or more processors may be configured to overlay graphics on top of the virtual companion.

In some embodiments, the visual assistant may be configured to be displayed with an appearance of a real human or a humanoid or a cartoon character based on the one or more users' choice. A set of pictures depicting the one or more users' choice can be uploaded to the artificial intelligence engine. The appearance of the visual assistant could be determined by analysis of the set of pictures by the artificial intelligence engine.

In some embodiments, the visual assistant may be configured to mimic different personalities. The visual assistant's gender, age and ethnicity may be determined by the artificial Intelligence's analysis on input from the one or more users. The virtual companion may be configured to be displayed in full body or half body portrait mode. The artificial intelligence engine may be configured for real-time speech recognition, speech to text generation, real-time dialog generation, text to speech generation, voice-driven animation, and human avatar generation.

In some embodiments, the artificial intelligence engine may be configured to emulate different voices and use different languages. A set of touch screens coupled to the one or more processors may be configured to allow the one or more users to interact with the visual assistant by hand. The set of microphones may be connected to loudspeakers. The set of microphones may be enabled to be beamforming. Pictures or voices of the one or more users may be configured to be uploaded and processed either on a cloud server or in local or personal devices to analyze and create the virtual companion.

In some embodiments, the virtual companion may be configured to be created based on the appearance of a real human character, the one or more user's own appearance, or a totally unidentifiable appearance created by the artificial intelligence. The visual companion may be configured to have eye contact with the one or more users. The visual companion may be configured to differentiate and identify the one or more users.

In some embodiments, the visual companion may be configured to switch eye contact when interacting with multiple users. The visual companion may be configured to switch to different personalities based on the analysis of one user who the visual companion may have eye contact with and has communicated with. The one user may be one user out of the one or more users. The virtual companion may be configured to shift interaction modes between one-to-one mode and one-to-more mode by using eye contact, pose and focus of attention.

In some embodiments, the selection of the goal model may be based on the input of the one or more users based on the needs of the one or more users after the one or more users may enter into the encounter area and analysis of the artificial intelligence engine. The set of goal models may be generated from the artificial intelligence with a number of human experts with non-public expertise. Non-public expertise may comprise knowledge, human interaction, human characters, human conversation and human physiology. The first encounter may be configured to include a first set of body movements and a first set of sign language by the visual companion. The second encounter may be configured to include a second set of body movements and a second set of sign language by the visual companion. In some embodiments, the visual companion may be providing a service of senior care. In some embodiments, the visual companion may be a service of visual dating service.

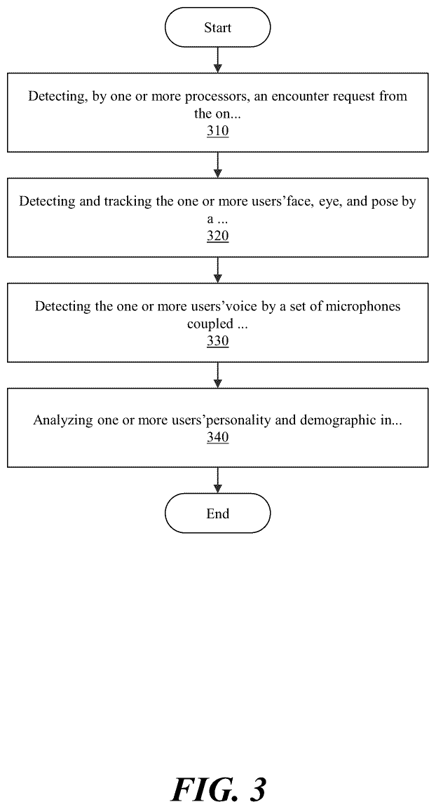

FIG. 3 is a flowchart that describes a method for providing an encounter, according to some embodiments of the present disclosure. In some embodiments, at 310, the method may include detecting, by one or more processors, an encounter request from the one or more users. At 320, the method may include detecting and tracking the one or more users' face, eye, and pose by a set of outward-facing cameras coupled to the one or more processors. At 330, the method may include detecting the one or more users' voice by a set of microphones coupled to the one or more processors. At 340, the method may include analyzing one or more users' personality and demographic information from audio-visual information gathered by the set of outward-facing cameras and the set of microphones.

In some embodiments, an artificial intelligence engine may be coupled to the one or more processors. The artificial intelligence engine may be trained by human experts in the field. The virtual companion may be configured to be displayed in LED/OLED displays, Android/iOS tablets, Laptops/PCs, or VR/AR goggles. A set of multi-layer info panels coupled to the one or more processors may be configured to overlay graphics on top of the virtual companion.

In some embodiments, the visual assistant may be configured to be displayed with an appearance of a real human or a humanoid or a cartoon character based on the one or more users' choice. A set of pictures depicting the one or more users' choice can be uploaded to the artificial intelligence engine. The appearance of the visual assistant could be determined by analysis of the set of pictures by the artificial intelligence engine.

In some embodiments, the visual assistant may be configured to mimic different personalities. The visual assistant's gender, age and ethnicity may be determined by the artificial Intelligence's analysis on input from the one or more users. The virtual companion may be configured to be displayed in full body or half body portrait mode. The artificial intelligence engine may be configured for real-time speech recognition, speech to text generation, real-time dialog generation, text to speech generation, voice-driven animation, and human avatar generation.

In some embodiments, the artificial intelligence engine may be configured to emulate different voices and use different languages. A set of touch screens coupled to the one or more processors may be configured to allow the one or more users to interact with the visual assistant by hand. The set of microphones may be connected to loudspeakers. The set of microphones may be enabled to be beamforming. Pictures or voices of the one or more users may be configured to be uploaded and processed either on a cloud server or in local or personal devices to analyze and create the virtual companion. The virtual companion may be configured to be created based on the appearance of a real human character, the one or more user's own appearance, or a totally unidentifiable appearance created by the artificial intelligence.

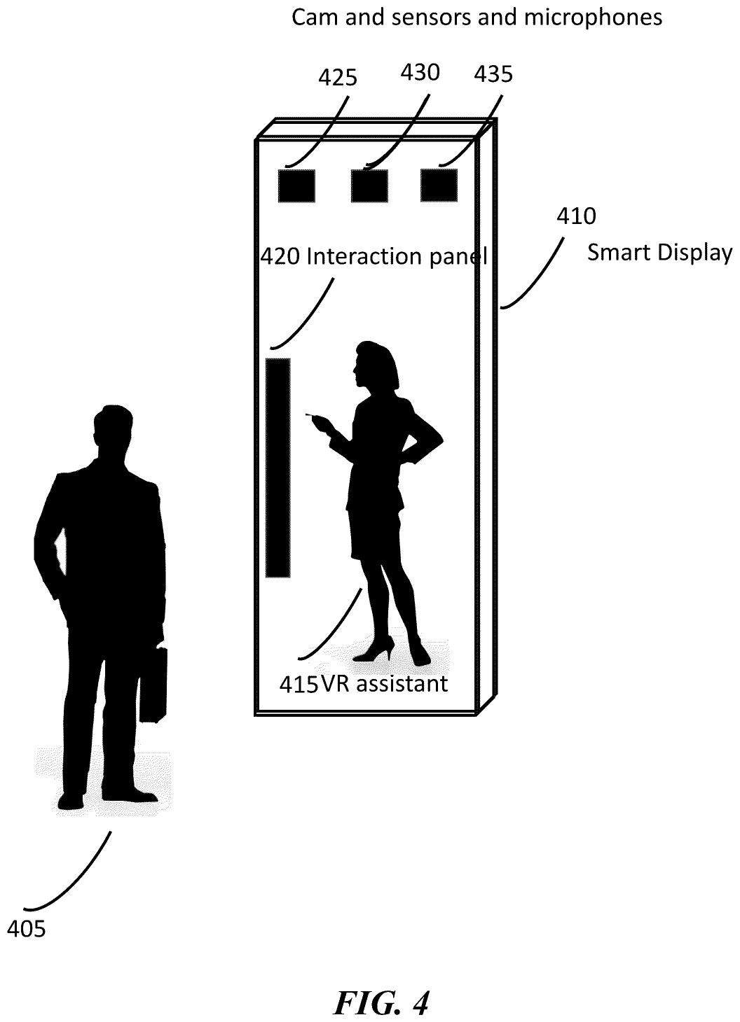

FIG. 4 is a diagram showing an example of providing an encounter of a visual assistant.

In some embodiments, a user 405 can approach a smart display 410. In some embodiments, the smart display 410 could be LED or OLED based. In some embodiments, interactive panels 420 is attached to the smart display 410. In some embodiments, a visual assistant 415 is configured to act as a human avatar, showing on the smart display 410. In some embodiments, the visual assistant 415 can be activated by sensor 425 that attached to the smart display 410 when the sensor 425 detects the user 405. In some embodiments, camera 430 and microphone 435 are attached to the smart display. In some embodiments, interactive panel 420, sensor 425, camera 430 and microphone 435 are coupled to a central processor. In some embodiments, interactive panel 420, sensor 425, camera 430 and microphone 435 are coupled to a server via wireless links. In some embodiments, the user 405 can interact with the visual assistant 415 using methods descripted in FIG. 1A, FIG. 1B, FIG. 2A, FIG. 2B, FIG. 3A and FIG. 3B and with help of interactive panel 420, sensor 425, camera 430 and microphone 435.

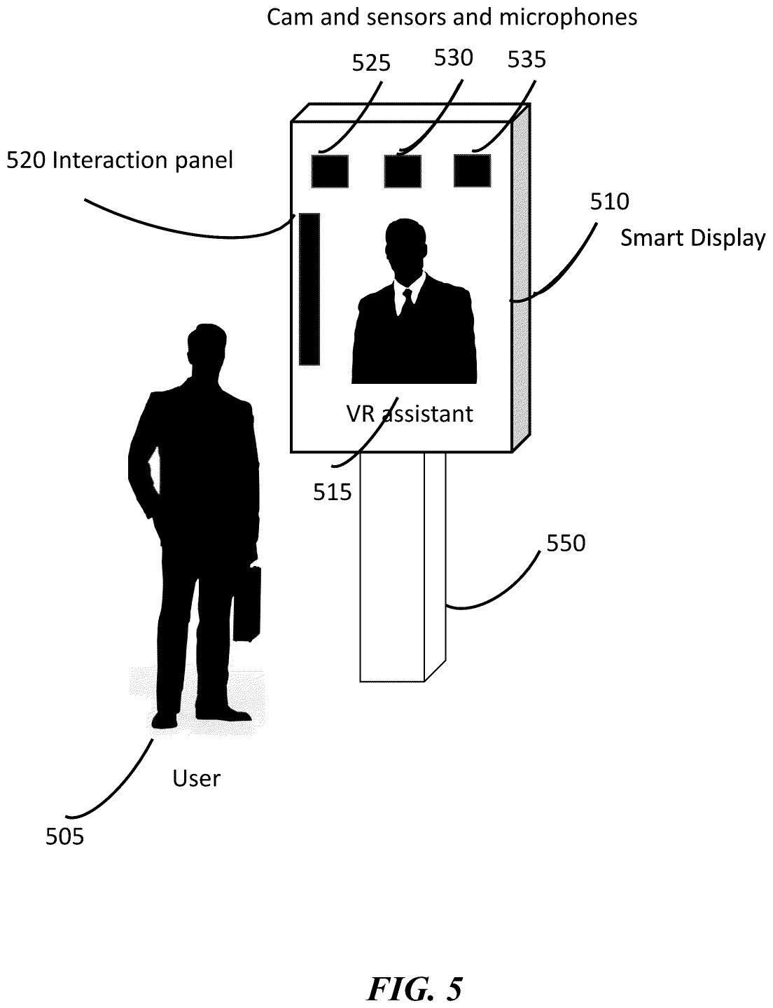

FIG. 5 is a second diagram showing an example of providing an encounter of a visual assistant.

In some embodiments, a user 505 can approach a smart display 510. In some embodiments, the smart display 510 could be LED or OLED based. In some embodiments, a support column 550 supports the smart display 510. In some embodiments, interactive panels 520 is attached to the smart display 510. In some embodiments, a visual assistant 515 is configured to act as a human avatar, showing on the smart display 510. In some embodiments, the visual assistant 515 can be activated by sensor 525 that attached to the smart display 510 when the sensor 525 detects the user 505. In some embodiments, camera 530 and microphone 535 are attached to the smart display. In some embodiments, interactive panel 520, sensor 525, camera 530 and microphone 535 are coupled to a central processor. In some embodiments, interactive panel 520, sensor 525, camera 530 and microphone 535 are coupled to a server via wireless link. In some embodiments, the user 505 can interact with the visual assistant 515 using methods descripted in FIG. 1A, FIG. 1B, FIG. 2A, FIG. 2B, FIG. 3A and FIG. 3B and with help of interactive panel 520, sensor 525, camera 530 and microphone 535.

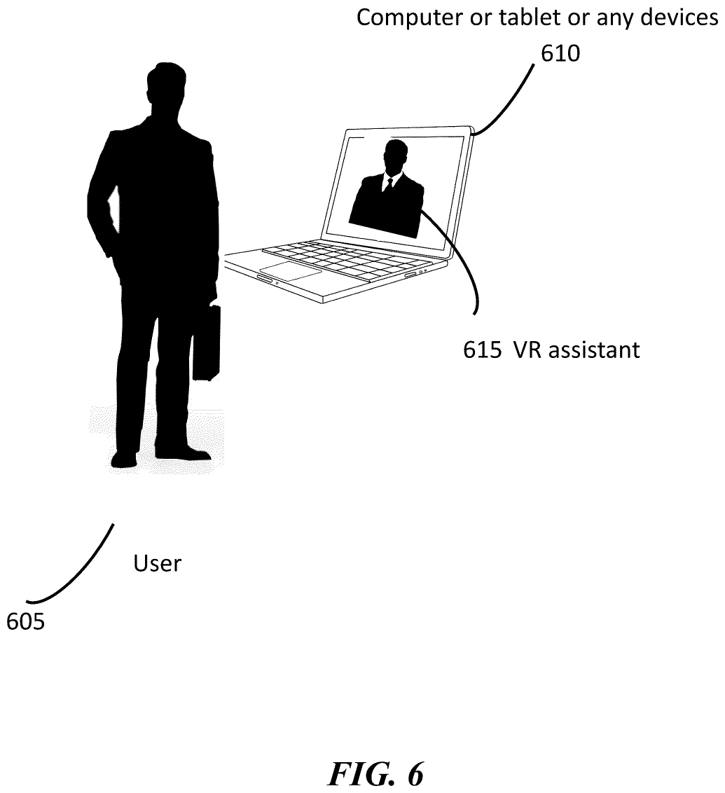

FIG. 6 is a diagram showing another example of providing an encounter of a visual assistant. In some embodiments, a user 605 can approach a computer 610. In some embodiments, the computer 610 could be laptop, desktop or tablet computer. In some embodiments, interactive panel, sensor, camera and microphone are attached to the computer 610. In some embodiments, interactive panel, sensor, camera and microphone are coupled to a central processor. In some embodiments, interactive panel, sensor, camera and microphone are coupled to a server via wireless links. In some embodiments, the user 605 can interact with the visual assistant 615 using methods descripted in FIG. 1A, FIG. 1B, FIG. 2A, FIG. 2B, FIG. 3A and FIG. 3B and with help of interactive panel, sensor, camera, microphone or keyboard of the computer 610.

In some embodiments, the visual assistant is configured to change adaptively in real time according to the statistics of the demographic information for potential consumers, wherein the information includes the age, gender, and occupation of the pedestrians, wherein the information is obtained from the passive visual sensing via a set of cameras with face/body patterns, wherein the information includes basic psychographic information, wherein the basic psychographic information includes attitude, feelings, interests, activities, and social structures, wherein the basic psychographic information is inferred and summarized through dynamic emotional state estimation and contextual analysis from computer vision based image/video understanding.

In some embodiments, the visual assistant be could be run by software either in local devices or on the cloud.

In some embodiments, the visual assistant could be cloned from a real person, wherein the visual assistant is configured to mimic the person's appearance, expressions, habits, voice, gestures and other appearances.

1. A method for providing an encounter via a virtual companion with artificial intelligence, the method comprising:
detecting, by one or more processors, an encounter request from a user, wherein an artificial intelligence engine is coupled to the one or more processors, wherein the artificial intelligence engine is trained by human experts in the field, wherein the virtual companion is configured to be displayed in LED/OLED displays, Android/iOS tablets, Laptops/PCs, or VR/AR goggles, wherein a set of multi-layer info panels coupled to the one or more processors are configured to overlay graphics on top of the virtual companion, wherein the visual assistant is configured to be displayed with an appearance of a real human or a humanoid or a cartoon character based on the user's choice, wherein a set of pictures depicting the user's choice can be uploaded to the artificial intelligence engine, wherein the appearance of the visual assistant could be determined by analysis of the set of pictures by the artificial intelligence engine, wherein the visual assistant is configured to mimic different personalities, wherein the visual assistant's gender, age and ethnicity is determined by the artificial Intelligence's analysis on input from the user; wherein the virtual companion is configured to be displayed in full body or half body portrait mode, wherein the artificial intelligence engine is configured for real-time speech recognition, speech to text generation, real-time dialog generation, text to speech generation, voice-driven animation, and human avatar generation, wherein the artificial intelligence engine is configured to emulate different voices and use different languages;
detecting and tracking the user's face, eye, and pose by a set of outward-facing cameras coupled to the one or more processors, wherein a set of touch screens coupled to the one or more processors is configured to allow the user to interact with the visual assistant by hand;
detecting the user's voice by a set of microphones coupled to the one or more processors, wherein the set of microphones are connected to loudspeakers, wherein the set of microphones are enabled to be beamforming, wherein pictures or voices of the user are configured to be uploaded and processed either on a cloud server or in local or personal devices to analyze and create the virtual companion, wherein the virtual companion is configured to be created based on the appearance of a real human character, user's own appearance, or a totally unidentifiable appearance created by the artificial intelligence;
analyzing user's personality and demographic information from audio-visual information gathered by the set of outward-facing cameras and the set of microphones;
selecting a best-matching personality for the user from a set of personalities based the analysis of the user's personality and demographic information from audio-visual information;
selecting a goal model from a set of goal models that each reflects a different type of assistance to be provided to the user by the virtual companion, wherein the selection of the goal model is based on the input of the user based on the needs of the user after the user enters into the encounter area and analysis of the artificial intelligence engine, wherein the set of goal models are generated from the artificial intelligence with a number of human experts with non-public expertise, wherein non-public expertise comprises knowledge, human interaction, human characters, human conversation, and human physiology;
selecting, by the one or more processors and the artificial intelligence engine, based on the goal model and responsive to the encounter request, a first encounter including a first representation and a first dialog output, wherein the first encounter is configured to include a first set of body movements and a first set of sign language by the visual companion; and
providing, by the one or more processors and the artificial intelligence engine, based on the goal model and responsive to the encounter request, the first encounter for presentation to the user on the virtual companion;
receiving, by the one or more processors and from the user, a first user reaction, the first user reaction including a first user dialog input and a first user engagement input; and
selecting, based on the first user reaction and using the goal model, a second encounter including a second representation and a second dialog output, wherein the second encounter is configured to include a second set of body movements and a second set of sign language by the visual companion;
providing, the second encounter for presentation to the user on the virtual companion.

2. A method for providing an encounter via a virtual companion with artificial intelligence in claim 1, wherein the visual companion is providing a service of senior care.

3. A method for providing an encounter via a virtual companion with artificial intelligence in claim 1, wherein the visual companion is providing a service of visual dating service.

4. A method for providing an encounter via a virtual companion for one or more users, with artificial intelligence, the method comprising:
detecting, by one or more processors, an encounter request from the one or more users, wherein an artificial intelligence engine is coupled to the one or more processors, wherein the artificial intelligence engine is trained by human experts in the field, wherein the virtual companion is configured to be displayed in LED/OLED displays, Android/iOS tablets, Laptops/PCs, or VR/AR goggles, wherein a set of multi-layer info panels coupled to the one or more processors are configured to overlay graphics on top of the virtual companion, wherein the visual assistant is configured to be displayed with an appearance of a real human or a humanoid or a cartoon character based on the one or more users' choice, wherein a set of pictures depicting the one or more users' choice can be uploaded to the artificial intelligence engine, wherein the appearance of the visual assistant could be determined by analysis of the set of pictures by the artificial intelligence engine, wherein the visual assistant is configured to mimic different personalities, wherein the visual assistant's gender, age and ethnicity is determined by the artificial Intelligence's analysis on input from the one or more users; wherein the virtual companion is configured to be displayed in full body or half body portrait mode, wherein the artificial intelligence engine is configured for real-time speech recognition, speech to text generation, real-time dialog generation, text to speech generation, voice-driven animation, and human avatar generation, wherein the artificial intelligence engine is configured to emulate different voices and use different languages,
detecting and tracking the one or more users' face, eye, and pose by a set of outward-facing cameras coupled to the one or more processors, wherein a set of touch screens coupled to the one or more processors is configured to allow the one or more users to interact with the visual assistant by hand;
detecting the one or more users' voice by a set of microphones coupled to the one or more processors, wherein the set of microphones are connected to loudspeakers, wherein the set of microphones are enabled to be beamforming, wherein pictures or voices of the one or more users are configured to be uploaded and processed either on a cloud server or in local or personal devices to analyze and create the virtual companion, wherein the virtual companion is configured to be created based on the appearance of a real human character, the one or more user's own appearance, or a totally unidentifiable appearance created by the artificial intelligence;
analyzing one or more users' personality and demographic information from audio-visual information gathered by the set of outward-facing cameras and the set of microphones;
selecting a best-matching personality for the one or more users from a set of personalities based the analysis of the one or more users' personality and demographic information from audio-visual information, wherein the visual companion is configured to have eye contact with the one or more users, wherein the visual companion is configured to differentiate and identify the one or more users, wherein the visual companion is configured to switch eye contact when interacting with multiple users, wherein the visual companion is configured to switch to different personalities based on the analysis of one user who the visual companion has eye contact with and has communicated with, wherein the one user is one user out of the one or more users, wherein the virtual companion is configured to shift interaction modes between one-to-one mode and one-to-more mode by using eye contact, pose and focus of attention;
selecting a goal model from a set of goal models that each reflects a different type of assistance to be provided to the one or more users by the virtual companion, wherein the selection of the goal model is based on the input of the one or more users based on the needs of the one or more users after the one or more users enters into the encounter area and analysis of the artificial intelligence engine, wherein the set of goal models are generated from the artificial intelligence with a number of human experts with non-public expertise, wherein non-public expertise comprises knowledge, human interaction, human characters, human conversation and human physiology;
selecting, by the one or more processors and the artificial intelligence engine, based on the goal model and responsive to the encounter request, a first encounter including a first representation and a first dialog output, wherein the first encounter is configured to include a first set of body movements and a first set of sign language by the visual companion; and
providing, by the one or more processors and the artificial intelligence engine, based on the goal model and responsive to the encounter request, the first encounter for presentation to the one or more users on the virtual companion;
receiving, by the one or more processors and from the one or more users, a first one or more users' reaction, the first one or more users reaction including a first one or more users dialog input and a first one or more users engagement input;
selecting, based on the first one or more users' reaction and using the goal model, a second encounter including a second representation and a second dialog output, wherein the second encounter is configured to include a second set of body movements and a second set of sign language by the visual companion; and
providing, the second encounter for presentation to the one or more users on the virtual companion.

5. A method for providing an encounter via a virtual companion with artificial intelligence for one or more users in claim 4, wherein the visual companion is providing a service of senior care.

6. A method for providing an encounter via a virtual companion with artificial intelligence for one or more users in claim 4, wherein the visual companion is a service of visual dating service

7. A method for providing an encounter via a virtual companion for one or more users, with artificial intelligence, the method comprising:
detecting, by one or more processors, an encounter request from the one or more users, wherein an artificial intelligence engine is coupled to the one or more processors, wherein the artificial intelligence engine is trained by human experts in the field, wherein the virtual companion is configured to be displayed in LED/OLED displays, Android/iOS tablets, Laptops/PCs, or VR/AR goggles, wherein a set of multi-layer info panels coupled to the one or more processors are configured to overlay graphics on top of the virtual companion, wherein the visual assistant is configured to be displayed with an appearance of a real human or a humanoid or a cartoon character based on the one or more users' choice, wherein a set of pictures depicting the one or more users' choice can be uploaded to the artificial intelligence engine, wherein the appearance of the visual assistant could be determined by analysis of the set of pictures by the artificial intelligence engine, wherein the visual assistant is configured to mimic different personalities, wherein the visual assistant's gender, age and ethnicity is determined by the artificial Intelligence's analysis on input from the one or more users; wherein the virtual companion is configured to be displayed in full body or half body portrait mode, wherein the artificial intelligence engine is configured for real-time speech recognition, speech to text generation, real-time dialog generation, text to speech generation, voice-driven animation, and human avatar generation, wherein the artificial intelligence engine is configured to emulate different voices and use different languages,
detecting and tracking the one or more users' face, eye, and pose by a set of outward-facing cameras coupled to the one or more processors, wherein a set of touch screens coupled to the one or more processors is configured to allow the one or more users to interact with the visual assistant by hand;
detecting the one or more users' voice by a set of microphones coupled to the one or more processors, wherein the set of microphones are connected to loudspeakers, wherein the set of microphones are enabled to be beamforming, wherein pictures or voices of the one or more users are configured to be uploaded and processed either on a cloud server or in local or personal devices to analyze and create the virtual companion, wherein the virtual companion is configured to be created based on the appearance of a real human character, the one or more user's own appearance, or a totally unidentifiable appearance created by the artificial intelligence;
analyzing one or more users' personality and demographic information from audio-visual information gathered by the set of outward-facing cameras and the set of microphones;
selecting a best-matching personality for the one or more users from a set of personalities based the analysis of the one or more users' personality and demographic information from audio-visual information, wherein the visual companion is configured to have eye contact with the one or more users, wherein the visual companion is configured to differentiate and identify the one or more users, wherein the visual companion is configured to switch eye contact when interacting with multiple users, wherein the visual companion is configured to switch to different personalities based on the analysis of one user who the visual companion has eye contact with and has communicated with, wherein the one user is one user out of the one or more users, wherein the virtual companion is configured to shift interaction modes between one-to-one mode and one-to-more mode by using eye contact, pose and focus of attention;
selecting a goal model from a set of goal models that each reflects a different type of assistance to be provided to the one or more users by the virtual companion, wherein the selection of the goal model is based on the input of the one or more users based on the needs of the one or more users after the one or more users enters into the encounter area and analysis of the artificial intelligence engine, wherein the set of goal models are generated from the artificial intelligence with a number of human experts with non-public expertise, wherein non-public expertise comprises knowledge, human interaction, human characters, human conversation and human physiology;
selecting, by the one or more processors and the artificial intelligence engine, based on the goal model and responsive to the encounter request, a first encounter including a first representation and a first dialog output, wherein the first encounter is configured to include a first set of body movements and a first set of sign language by the visual companion; and
providing, by the one or more processors and the artificial intelligence engine, based on the goal model and responsive to the encounter request, the first encounter for presentation to the one or more users on the virtual companion.
